(19) United States
(12) Patent Application Publication
(10) Pub. No.: US 2024/0040971 A1
(43) Pub. Date: Feb. 8, 2024

(54) PLANT HOLDER FOR PLANT CULTIVATION OBJECT

(71) Applicant: Yannick DESMARAIS, Pierreville (CA)

(72) Inventors: Yannick DESMARAIS, Pierreville (CA); Alexandre MICHAUD THIBAULT, Granby (CA)

(21) Appl. No.: 18/257,432

(22) PCT Filed: Jul. 9, 2021
(86) PCT No.: PCT/CA2021/050945

§ 371 Date: Jun. 14, 2023

Related U.S. Application Data
(60) Provisional application No. 63/124,971, filed on Dec. 14, 2020.

(51) Int. Cl. A01G 9/02; A01G 27/00

(52) U.S. Cl. CPC A01G 9/023; A01G 27/005

(57) ABSTRACT

A plant cultivation object includes a body having an upright orientation and extending along a longitudinal axis, the body having external walls with plant cavities. Plant holders are receivable in the plant cavities. The plant holders have one or more outer walls and one or more inner walls spaced inwardly from the outer walls. The one or more inner walls delimit a hole. The plant holders are resiliently deformable. The plant cultivation object is rotatable about its own axis.

### CROSS-REFERENCE TO RELATED APPLICATIONS

This application claims priority to U.S. provisional patent application 63/124,971 filed Dec. 14, 2020, the entire contents of which are incorporated by reference herein.

### TECHNICAL FIELD

The application relates generally to plant cultivation and, more particularly, to plant cultivation objects.

### BACKGROUND

Upright cultivation towers allow for growing multiple plants over a relatively small footprint. The plants must be mounted to the cultivation towers, and removed from the towers when harvested. The plants must be supplied with water, light, and nutrients. Mounting and removing the plants may be laborious, and spillage, leakage or a mess may result when supplying the plants with water or nutrients.

### SUMMARY

There is disclosed a plant cultivation object, comprising: a body having an upright orientation and extending along a longitudinal axis, the body having external walls with plant cavities; and a rotation system including a base supporting the body and rotatable about the longitudinal axis, a strap engaged with the base to rotate the base about the upright axis, and a motor drivingly engaged to the strap.

There is disclosed a plant cultivation object, comprising: a body having an upright orientation and extending along a longitudinal axis, the body having external walls with plant cavities; and plant holders receivable in the plant cavities, the plant holders having one or more outer walls and one or more inner walls spaced inwardly from the outer walls, the one or more inner walls delimiting a hole, the plant holders being resiliently deformable.

There is disclosed a plant cultivation object rotation system, comprising: a base supporting for supporting a plant cultivation object and rotatable about an axis of the base, a strap engageable with the base to rotate the base about the axis, and a motor drivingly engageable to the strap.

There is disclosed a plant holder mountable within a cavity of a plant cultivation object, the plant holder comprising: one or more outer walls and one or more inner walls spaced inwardly from the outer walls, the one or more outer walls abutting against the cavity upon the plant holder being mountable therein, the one or more inner walls delimiting a hole, a slot extending from the hole outwardly through the one or more inner and outer walls, the plant holder being resiliently deformable.

The plant cultivation object, the plant holder and/or the plant cultivation object rotation system may include any of the following features, in any combination.

In an embodiment, the strap is under tension and frictionally engages an outer surface of the base free of slip between the strap and the outer surface.

In an embodiment, the rotation system includes a drive wheel spaced apart from the base and engaged to the strap, the drive wheel drivingly engaged to the motor.

In an embodiment, the drive wheel is rotatable about a drive wheel axis being parallel to the longitudinal axis.

In an embodiment, the drive wheel is spaced apart from the base to tension the strap.

In an embodiment, a support supports the body and a bearing system disposed between the support and the base.

In an embodiment, the bearing system includes bearing plates disposed against the support and rotatable bearing elements housed by the bearing plates, the rotatable bearing elements support the base.

In an embodiment, the base has drainage holes extending through a bottom of the base.

In an embodiment, plant holders are receivable in the plant cavities, the plant holders having one or more outer walls and one or more inner walls spaced inwardly from the outer walls, the one or more inner walls delimiting a hole, the plant holders being resiliently deformable.

In an embodiment, the plant holders are resiliently deformable to vary a size of the hole.

In an embodiment, the plant holders have a slot extending from the hole outwardly through the one or more inner walls and the one or more outer walls.

In an embodiment, the plant holders have an upper surface and a lower surface, a groove extending into the plant holders from one of the upper and lower surfaces toward the other of the upper and lower surfaces.

In an embodiment, the plant holders are made from a rubber-like material.

In an embodiment, one or more apertured cups are receivable in one of the plant cavities, the plant holder being removably received in each apertured cup.

In an embodiment, one or more plants are removably received in the hole of one of the plant holders.

In an embodiment, a plant growth media is removably received in the hole of one or more of the plant holders.

In an embodiment, a lighting system has an upright lighting arm spaced horizontally from the external walls of the body, and light emitting diodes (LEDs) disposed vertically along the lighting arm.

There is disclosed a method of rotating a plant cultivation object about an upright axis, the method comprising: driving a strap engaged to a surface of the plant cultivation object to rotate the plant cultivation object about the upright axis.

The method may include any of the following features, in any combination.

In an embodiment, driving the strap includes driving the strap with a motor.

In an embodiment, driving the strap includes driving a wheel with the motor, in order to drive the strap.

In an embodiment, driving the strap includes displacing the strap along a curved outer surface of the plant cultivation object with no slip.

In an embodiment, the method includes supporting the plant cultivation object with rotatable bearing elements disposed underneath the plant cultivation object.

There is disclosed a method of mounting a cultivatable plant onto a plant cultivation object, the method comprising: inserting the cultivatable plant into a hole of a plant holder to support the cultivatable plant with the plant holder, the plant holder being resiliently deformable; and mounting the plant holder with the cultivatable plant to an external wall of the plant cultivation object.

The method may include any of the following features, in any combination.

In an embodiment, inserting the cultivatable plant into the hole includes resiliently deforming the plant holder to obtain a desired size of the hole.

In an embodiment, inserting the cultivatable plant into the hole includes resiliently deforming the plant holder to vary a size of the hole.

In an embodiment, mounting the plant holder with the cultivatable plant includes squeezing the plant holder to reduce its size.

In an embodiment, mounting the plant holder with the cultivatable plant includes inserting the plant holder with the cultivatable plant into a cavity of the external wall of the plant cultivation object.

### DESCRIPTION OF THE DRAWINGS

Reference is now made to the accompanying figures in which:

FIG. 1A is a perspective view of plant cultivation objects;

FIG. 1B is a perspective view of plant cavities of one of the plant cultivation objects of FIG. 1A;

FIG. 1C is a perspective view of a plant holder in one of the plant cavities of one of the plant cultivation objects of FIG. 1A;

FIG. 2A is a top view of the plant holder of FIG. 1C;

FIG. 2B is a bottom view of the plant holder of FIG. 1C;

FIG. 2C is a perspective view of the bottom of the plant holder of FIG. 1C;

FIG. 2D is a perspective view of the plant holder of FIG. 1C in an apertured cup;

FIG. 3A is a perspective view of a cultivatable plant and plant growth media in the plant holder of FIG. 1C;

FIG. 3B is another perspective view of the cultivatable plant and the plant growth media in the plant holder of FIG. 1C;

FIG. 3C is a perspective view of the cultivatable plant and another plant growth media in the plant holder of FIG. 1C;

FIG. 4A is a perspective view of a lighting system of one of the plant cultivation objects of FIG. 1A;

FIG. 4B is a perspective view of part of the lighting system of FIG. 4A;

FIG. 4C is another perspective view of part of the lighting system of FIG. 4A;

FIG. 4D is a side elevational view of part of the lighting system of FIG. 4A;

FIG. 5 is a perspective view of another lighting system for a plant cultivation object;

FIG. 6 is a perspective view of another lighting system for a plant cultivation object;

FIG. 7A is a perspective view of a rotation system of one of the plant cultivation objects of FIG. 1A;

FIG. 7B is an enlarged view of area VIIB-VIIB of FIG. 7A;

FIG. 8A is a top view of part of a table of the plant cultivation objects of FIG. 1A;

FIG. 8B is a top view of a base of the rotation system of FIG. 7A;

FIG. 8C is a perspective view of the base of the rotation system on the table of FIG. 8A;

FIG. 9A is a perspective view of a cap of the plant cultivation objects of FIG. 1A;

FIG. 9B is another perspective view of the cap of FIG. 9A;

FIG. 9C is a perspective view of the cap in one of the plant cavities of one of the plant cultivation objects of FIG. 1A;

FIG. 9D is another perspective view of the cap in one of the plant cavities of one of the plant cultivation objects of FIG. 1A;

FIG. 10 is a perspective view of another plant cultivation object;

FIG. 11 is a perspective view of another plant cultivation object; and

FIG. 12 is a perspective view of another plant cultivation object.

### DETAILED DESCRIPTION

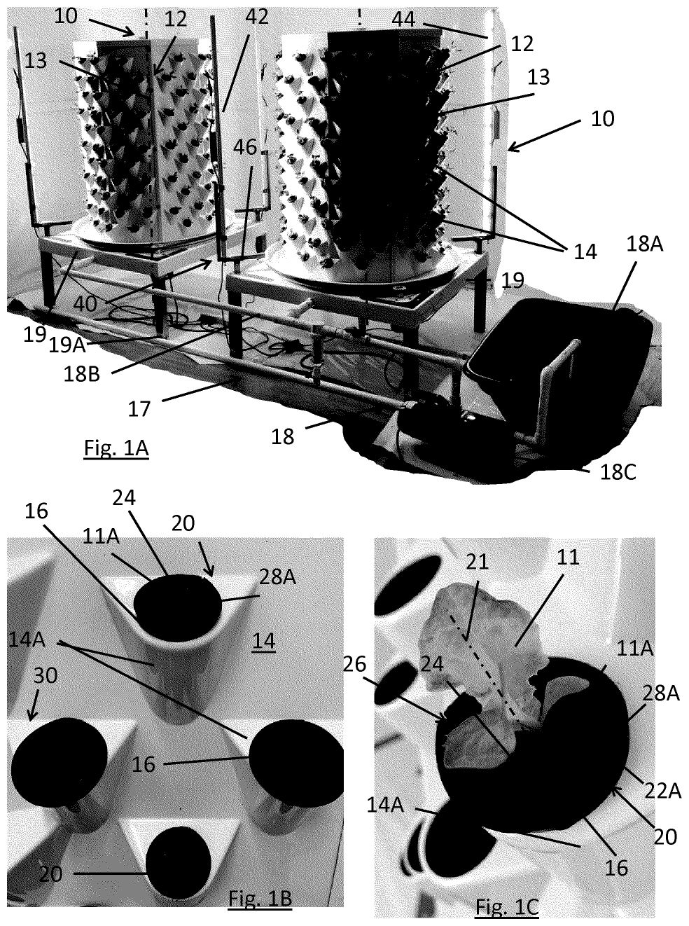

FIGS. 1A to 1C show plant cultivation objects 10. Each plant cultivation object 10 is used to grow plants 11 for consumption, display, or other desired use. The plants 11 are cultivatable because they are grown with the plant cultivation object 10 so that some or all of each plant 11 is harvested. The plants 11 may be provided to the plant cultivation object 10 at any stage of their development, from non-germinated seeds, to seedlings, to larger plants 11. The plants 11 may be mounted to the plant cultivation object 10 via their base. The base may include a root base housed or supported by a plant growth media 11A such as soil or mesh. One possible example of the plant growth medium 11A is a Jiffypot™.

The plant cultivation objects 10 in FIGS. 1A to 1C are in the form of towers. Therefore, the plant cultivation object 10 may sometimes be referred to herein as “plant cultivation tower 10” or simply “tower 10”. The tower 10 is upright and its height is greater than its width, and greater than its length. It will be appreciated that the plant cultivation object 10 may be any other body used to support the plants 11 for cultivation, which may extend along a horizontal axis, a vertical axis, or some combination in between. The term “tower” therefore does not limit the plant cultivation object 10 to being a tall structure, or a vertically-oriented body.

Referring to FIGS. 1A to 1C, each tower 10 has a body 12 which provides structure to the tower 10 and forms the corpus thereof. The body 12 is a structure used to support the plants 11 and is exposed to light. The body 12 has an upright orientation, and its height is greater than its width, and greater than its length. The body 12 extends along a longitudinal axis 13. The body 12 has one or more external walls 14 which are exposed to light. Each of the external walls 14 has one or more plant cavities 16 to receive the plant 11, in any stage of development, so that it can be cultivated by the tower 10. Referring to FIGS. 1B and 1C, the plant cavities 16 are grooves extending into protrusions 14A which project outwardly from the external walls 14 of the body 12. Each of the plant cavities 16 has an opening in fluid communication with an interior of the tower 10, so that water and/or other nutrients can be provided to the plant 11 within the plant cavity 16 via the interior of the tower 10. Other configurations for the plant cavities 16 are possible. For example, the plant cavities 16 may extend into the external wall 14 itself and be recessed within the body 12. The number of plant cavities 16 per external wall 14 may vary, and be selected based on multiple factors such as the type of plants 11 being cultivated, the size of the body 12, and the light to which the external wall 14 will be exposed.

The shape of the body 12, and thus the shape of the tower 10, may be a function of the number, type, and arrangement of the external walls 14. The external walls 14 may be planar or curved. In a configuration where the body 12 is a cylinder, the body 12 has one external wall 14 that is curved. In a configuration where the body 12 is a box, the body 12 may have four external walls 14 that are each planar, where adjacent external walls 14 are connected along a common edge. In a configuration where the body 12 is another type of three dimensional object, such as one with eight sides as shown in FIG. 1A, the body 12 has eight external walls 14 where adjacent external walls 14 are connected along a common edge. It is therefore understood that the body 12, and thus the tower 10, may have any suitable shape.

Referring to FIG. 1A, the towers 10 are part of a plant cultivation system 17. The plant cultivation system 17 includes components which function together to grow the plants 11 of the towers 10 for consumption or display. The plant cultivation system 17 has an irrigation system 18 which has a reservoir 18A of water and/or other nutrients, one or more pipes 18B that extend from the reservoir 18A to the towers 10, and a pump 18C to displace the liquids from the reservoir 18A, through the pipes 18B and to the towers 10. The body 12 is hollow in FIG. 1A, and the pipes 18B have an outlet within the interior of the body 12. The outlet of the pipes 18B has a nozzle, sprinkler or other suitable device to irrigate the roots of the plants 11 from within the body 12. Excess water may collect and be drained through the pipes 18B back into the reservoir 18A and/or pump 18C. The plant cultivation system 17 includes a support table 19 which supports the body 12 of each tower 10. The legs of the support table 19 may have wheels 19A to displace the support table 19. The plant cultivation system 17 may have other components as well.

Referring to FIGS. 1B and 1C, multiple plant holders 20 are used to receive and support the plants 11, and to mount them into the plant cavities 16. In FIGS. 1B and 1C, each plant holder 20 is mounted within one of the plant cavities 16. In an alternate embodiment, more than one plant holder 20 is mounted into one of the plant cavities 16. The plant holders 20 are removably mounted into the plant cavities 16 such that they can be inserted into, and removed from, the plant cavities 16 without difficulty, and without having to use tools. When inserted into the plant cavities 16, the plant holders 20 securely support the plant 11.

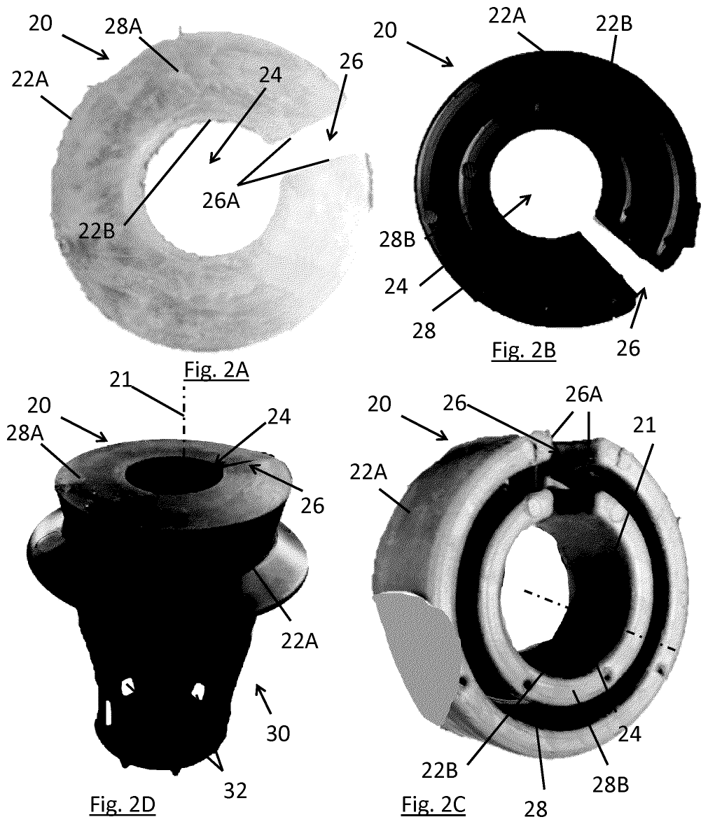

FIGS. 2A to 2C show one of the plant holders 20. The plant holder 20 has one or more outer walls 22A and one or more inner walls 22B that are spaced inwardly from the outer walls 22A. The outer walls 22A face the surfaces delimiting the plant cavity 16 when the plant holder 20 is inserted into the plant cavity 16 (see FIG. 1C). The outer walls 22A abut against the surfaces delimiting the plant cavity 16 when the plant holder 20 is inserted into the plant cavity 16 (see FIG. 1C). The shape of the plant holder 20 may be a function of the number, type, and arrangement of the outer walls 22A. The outer walls 22A may be planar or curved. In a configuration where the plant holder 20 is a cylinder, as shown in FIGS. 2A to 2C, the plant holder has one outer wall 22A that is curved. In a configuration where the plant holder 20 is a multiple-sided body, the plant holder 20 may have multiple outer walls 22A, where adjacent outer walls 22A are connected along a common edge. It is therefore understood that the plant holder 20 may have any suitable shape to be received in the plant cavity 16, which may or may not be correspondingly shaped. The plant holder 20 may taper toward one of its ends. The number, arrangement, and shape of the inner walls 22B may vary in a similar fashion.

The inner walls 22B delimit a hole 24 of the plant holder 20. The hole 24 is an aperture in the plant holder 20 into which the plant 11 is received. In FIGS. 2A to 2C, the hole 24 is round and is delimited by one annular inner wall 22B. In FIGS. 2A to 2C, the hole 24 is a central hole of the plant holder 20. The hole 24 is circular and concentric with a longitudinal center axis 21 of the plant holder 20. The hole 24 is positioned radially inwardly of the outer walls 22A relative to the center axis 21. The hole 24 extends through all of the plant holder 20 and is a through-hole, thereby allowing the roots of the plant 11 to be irrigated when the plant holder 20 is received in the plant cavity 16. In an alternate embodiment, the hole 24 is a groove that extends only partially through the plant holder 20, such that the plant 11 therein is irrigated from the top of the hole 24. In FIGS. 2A to 2C, the outer and inner walls 22A,22B have the same shape. In an alternate embodiment, the shape of the outer walls 22A is different from the shape of the inner walls 22B. In one possible configuration where the shape of the outer walls 22A is different from the shape of the inner walls 22B, the plant holder 20 has one curved outer wall 22A providing a cylindrical outer shape, and four planar inner walls 22B delimiting a rectangular-shaped hole 24.

Referring to FIGS. 2A to 2C, the plant holder 20 is resiliently deformable. A force is applied against the plant holder 20 to change its shape and/or size, and the plant holder 20 reverts to a default or non-deformed shape and size when the force is removed. The plant holder 20 is thus deformed only temporarily, and is able to return to a non-deformed shape and size after being deformed. The resilient deformability of the plant holder 20 helps to easily insert and remove it from the plant cavity 16. The resilient deformability of the plant holder 20 also helps to easily accommodate plants 11 of various sizes, or at various stages of growth, because the size of the plant holder 20, and thus of the hole 24, may be varied. The resilient deformability of the plant holder 20 also helps to secure the plant 11 within the plant holder 20. When the plant holder 20 returns to its non-deformed position after the plant 11 has been inserted into the hole 24, the resiliency of the plant holder 20 may cause the inner walls 22B to exert a force against the root base and growth media 11A of the plant 11. This force generates a frictional contact between the inner walls 22B and the root base and growth media 11A of the plant 11, thereby helping to secure the plant 11 in the plant holder 20. This secure engagement between the root base and growth media 11A and the inner walls 22B facilitates cleanliness and facilitates irrigation because the root base and growth media 11A are held in position by the inner walls 22B of the plant holder 20.

The following description of the operation of the plant holder 20 when it is a cylinder further illustrates these functions of the resilient plant holder 20. It will be appreciated that a differently-shaped plant holder 20 may also have the same functions now further described. Referring to FIGS. 2A to 2C, a user may squeeze the cylindrical plant holder 20 to reduce the diameter of the outer wall 22A, thereby facilitating the insertion of the plant holder 20 into the plant cavity 16 and its removal therefrom. To accommodate different sizes of the root base and growth media 11A of the plant 11, the user may push the root base and growth media 11A through the hole 24, thereby causing the diameter of the inner wall 22B to increase. When the root base and growth media 11A are within the hole 24, the resiliency of the plant holder 20 will cause the inner wall 22B to exert a radially inward force in the direction of the longitudinal center axis 21 of the plant holder 20, to cause a frictional engagement between the inner wall 22B and the root base and growth media 11A of the plant 11.

The resilient deformability of the plant holder 20 may result from the material from which the plant holder 20 is made, the features of the plant holder 20, or any combination of the preceding, as now described in greater detail.

A feature of the plant holder 20 which contributes to its resilient deformability is a slot 26. Referring to FIGS. 2A to 2C, the slot 26 extends outwardly from the hole 24 and intersects the hole 24, and through both the inner and outer walls 226,22A. In the illustrated configuration where the plant holder 20 is cylindrical, the slot 26 extends along a line radial to the center axis 21 of the plant holder 20. The slot 26 helps provide resilient deformability to the plant holder 20 by making the outer and inner walls 22A,22B discontinuous, thereby increasing their flexibility. The slot 26 allows for moving the inner walls 22B outwardly to enlarge the hole 24 and remove the plant 11. The slot 26 also allows the hole 24 to be enlarged to receive different sizes of the root base and growth media 11A of the plant 11. The slot 26 is delimited by planar end walls 26A which are spaced apart from each other. The slot 26 closes when it is inserted into the plant cavity 16 (see FIG. 1C). The upright end walls 26A may be brought into contact which each other when the slot 26 closes (see FIG. 1C). In FIGS. 2A to 2C, the size of the slot 26 varies as it extends outwardly from the hole 24. In FIGS. 2A to 2C, the size of the slot 26 increases as it extends from the hole 24 to the outer wall 22A, such that the circumferential extent of the slot 26 is greater at the outer wall 22A than at the inner wall 22B. In alternate embodiments, the plant holder 20 has more than one slot 26.

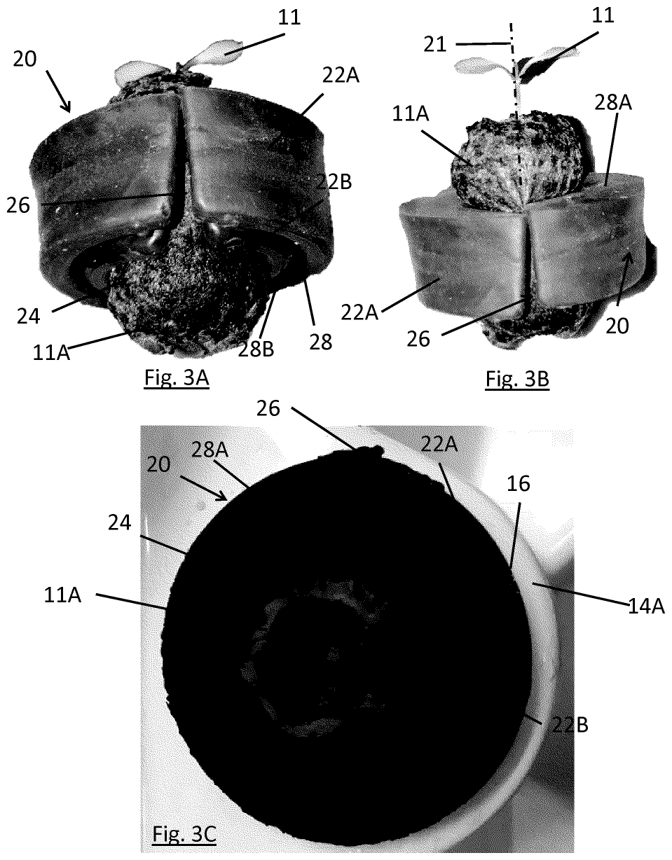

Another feature of the plant holder 20 which contributes to its resilient deformability is a groove 28. Referring to FIGS. 2A to 2C, the groove 28 extends into the body of the plant holder 20. The groove 28 extends into the body of the plant holder 20 from an upper surface 28A or from a lower surface 28B of the plant holder 20. The upper surface 28A is exposed and the lower surface 28B faces toward the body 12 when the plant holder 20 is inserted into the plant cavity 16. In FIGS. 2A to 2C, the groove 28 extends into the body from the lower surface 28B and is not visible at the upper surface 28A. In an alternate embodiment, the groove 28 extends into the body from the upper surface 28A and is not visible at the lower surface 28B. The groove 28 does not extend through all of the body of the plant holder 20. In an alternate embodiment, the groove 28 or parts thereof extend through all of the plant holder 20 and intersects the upper and lower surfaces 28A,28B. In the illustrated configuration where the plant holder 20 is cylindrical, the groove 28 is annular and extends circumferentially about the center axis 21. In the illustrated configuration where the plant holder 20 is cylindrical, the groove 28 is disposed radially between the outer and inner walls 22A,22B. In the illustrated configuration where the plant holder 20 is cylindrical, the groove 28 extends in a direction parallel to the center axis 21. The plant holder 20 may have more than one groove 28. The multiple grooves 28 may be arranged concentrically. The groove 28 helps provide resilient deformability to the plant holder 20 by allowing both of the outer and inner walls 22A,22B to more easily displace radially inwardly and radially outwardly, relative to each other, when the plant holder 20 is temporarily deformed. The groove 28 allows the root base and growth media 11A of the plant 11 to abut against and expand the inner wall 22B without causing the outer wall 22A, and thus the entire plant holder 20, to expand. When the inner wall 22B expands in this manner, the groove 28 is reduced in size (see FIG. 3A). When the inner wall 22B expands in this manner, the radial thickness of the groove 28 is reduced (see FIG. 3A). The groove 28 reduces the weight of the plant holder 20 and saves material costs.

Another feature of the plant holder 20 which contributes to its resilient deformability is the material from which the plant holder 20 is made. The plant holder 20 may be made of an elastomer, such as rubber or other vulcanisates. The plant holder 20 may be made out of silicone. The plant holder 20 may be made of any suitable material which allows the plant holder 20 to recover from deformations quickly without the need for applying external force, and which is capable of withstanding elongation before fracture.

Referring to FIGS. 2D and 1B, the tower 10 may also have one or more apertured cups 30 which are removably receivable in one of the plant cavities 16. The plant holder 20 with the plant 11 therein may be removably received in one of the apertured cups 30, which is itself removably receivable in one of the plant cavities 16. The apertured cups 30 have through holes 32 which allow for root growth and for irrigation of the roots.

Referring to FIGS. 3A and 3B, the plant 11 and its root base and growth media 11A are securely mounted within the plant holder 20. The root base and growth media 11A are within the hole 24, and the inner wall 22B is expanded in size compared to its non-deformed state. The expanded inner wall 22B reduces the size of the groove 28. The resiliency of the plant holder 20 causes the inner wall 22B to exert a radially inward force in the direction of the longitudinal center axis 21 of the plant holder 20, to cause a frictional engagement between the inner wall 22B and the root base and growth media 11A of the plant 11. The root base and growth media 11A protrude past the plant holder 20 and through the hole 24 such that they are exposed, which facilitates irrigation of the plant 11 when the plant holder 20 is within the plant cavity 16. FIG. 3C shows another possible plant growth media 11A in the hole 24 delimited by the inner wall 22B.

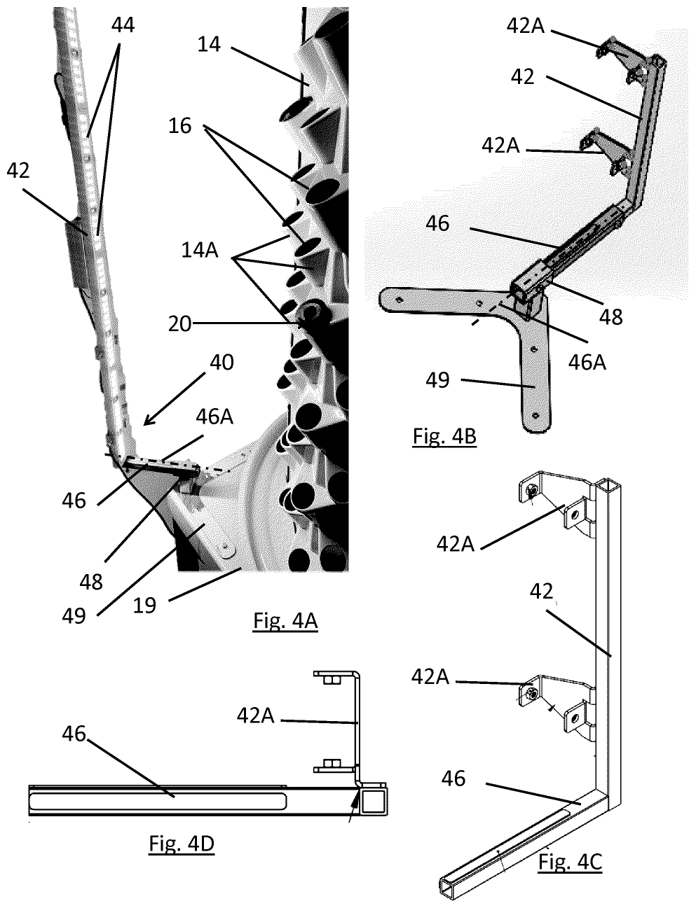

Referring to FIGS. 4A to 4D, the tower 10 has a lighting system 40. The lighting system 40 provides light for the plants 11 of the tower 40 so that they can grow. The lighting system 40 includes one or more lighting arms 42 that have an upright orientation. Each lighting arm 42 accommodates one or more lights 44 along the height of the lighting arm 42. Each lighting arm 42 may have lighting brackets 42A spaced apart vertically from each other along the height of the lighting arm 42. The lights 44 in FIGS. 4A to 4D are light emitting diodes (LEDs). Each lighting arms 42 is spaced horizontally from the external walls 14 of the body 12 of the tower 10.

The distance of each lighting arm 42, and thus of the lights 44, from the external surface 14 of the body 12 may be varied. In FIGS. 4A to 4D, each lighting arm 42 is mounted to, or part of, a connector arm 46 which structurally links the lighting arm 42 to the support table 19. The connector arm 46 spaces the lighting arm 42 from the support table 19 such that the lighting arm 42 is suspended off of, or cantilevered from, the support table 19. The connector arm 46 has a horizontal orientation in FIGS. 4A to 4D, but may have another orientation. The connector arm 46 is displaceable along a linear direction parallel to an elongated axis 46A of the connector arm 46, to displace the lighting arm 42 and the lights 44 toward and away from the external surface 14 of the body 12. Different configurations of this functionality are possible. In FIGS. 4A to 4D, the connector arm 46 is mounted through, and displaceable relative to, a hollow bracket 48. The hollow bracket 48 is mounted to a corner of the support table 19 via a corner support 49. The corner support 49 is an L-bracket attached to a corner of the support table 19. In FIGS. 4A to 4D, the connector arm 46 is telescopic or expandable along the elongated axis 46A.

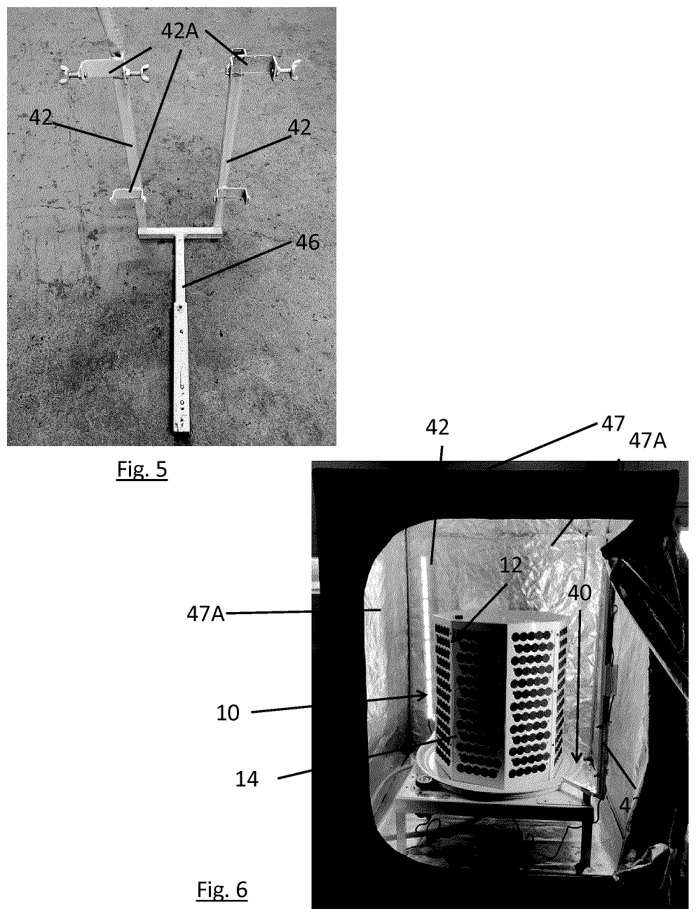

Other configurations for the lighting system 40 are possible. For example, and referring to FIG. 5, the two lighting arms 42 may be supported by a single connector arm 46. For example, and referring to FIG. 6, the lighting system 40 may include a lighting box 47. The lighting box 47 has interior walls 47A made of light reflective material, and encloses the tower 10 maximise the exposure of the external walls 14 to light from the lighting arms 42.

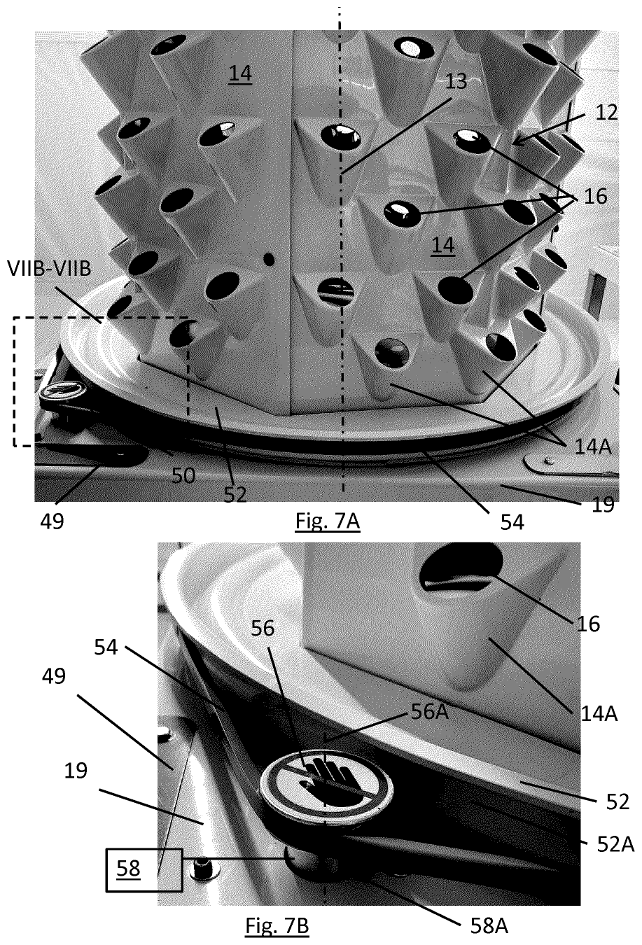

Referring to FIGS. 7A and 7B, the tower 10 is rotatable about an upright axis to expose the plants 11 to all available light. The body 12 is rotatable about the upright longitudinal axis 13. The rotation of the body 12 may be achieved with a rotation system 50. The rotation system 50 including a base 52 underneath and supporting the body 12. The base 52 is driven to rotate the upright axis 13. Different configurations are possible to rotatably drive the base 52. In FIGS. 7A and 7B, the rotation system 50 includes a strap 54 that is engaged with the base 52. The strap 54 is wrapped or extends around a circumferential outer surface 52A of the base 52 and is in contact with the outer surface 52A. The strap 54 is under tension. The tensioned strap 54 frictionally engages the outer surface 52A such that there is no slip between the strap 54 and the outer surface 52A. Therefore, movement of the strap 54 will cause the base 52 to rotate about the upright axis 13. The strap 54 may be made of any suitable elastomeric material. The rotation system 50 is shown as a feature of the tower 10, but it may be provided as a kit or assembly of components to be assembled together and used to modify, upgrade or repair an existing tower 10.

The rotation system 50 has a drive wheel 56 which is positioned above the surface of the support table 19 and which rotates about an upright drive wheel axis 56A. The drive wheel axis 56A is parallel to the upright axis 13 of the body 12 and spaced laterally apart therefrom. The drive wheel 56 is spaced apart from the base 52 and frictionally engages the strap 54 such that there is no slip between the drive wheel 56 and the strap 54. The spacing of the drive wheel 56 from the base 52 helps to provide the tension to the strap 54 and maintain its frictional engagement with both the drive wheel 56 and the outer surface 52A of the base 52. The drive wheel 56 is driven by a motor 58. The motor 58 is electric in the illustrated embodiment, but may be of another type. The motor 58 drives a drive shaft 58A which is mounted to the drive wheel 56 so as to rotate the drive wheel 56 about the drive wheel axis 56A. The rotation of the drive wheel 56 causes the strap 54 to displace, and thereby causes the base 52 to rotate about the upright axis 13 to rotate the tower 10 about the upright axis 13. Other configurations are possible to rotate the base 52.

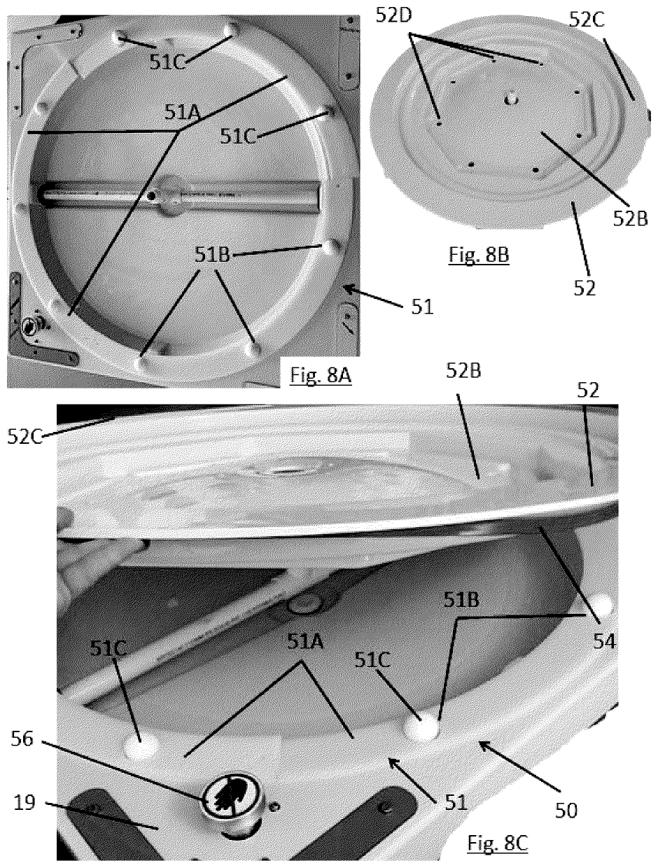

Referring to FIGS. 8A to 8C, other features of the rotation system 50 are shown. The base 52 is in the form of a plate. The base 52 has a depression 52B formed in an upper surface 52C of the base 52. The depression 52B is shaped and sized to receive therein the body 12 of the tower 10. The depression 52B has an octagonal shape to receive the octagonal-shaped body 12 of the tower 10. Other shapes for the depression 52B are possible. The base 52 has drainage holes 52D extending through the bottom of the base 52 in the location of the depression 52B to drain water that accumulates within the base 52.

Referring to FIGS. 8A and 8C, the rotation system 50 includes a bearing system 51. The bearing system 51 supports the tower 10 and its rotation about the axis 13. The bearing system 51 includes bearing plates 51A resting on part of the support table 19. Referring to FIGS. 8A and 8C, each bearing plate 51A is an arc segment and the bearing plates 51A are arranged in a circle, such that the circumferential extremities of each bearing plate 51A abut against the circumferential extremities of another bearing plate 51A. Each bearing plate 51A has one or more bearing holes 51B. A bearing element 51C is received in each bearing hole 51B and is kept in place by the body of the bearing plate 51A delimiting the bearing hole 51B. The bearing elements 51C in FIGS. 8A and 8C are ball bearings 51C. The bearing system 50 function as follows. The base 52, which supports the body 12 of the tower 10, is placed on the bearing elements 51C and the underside of the base 52 rests on the bearing elements 51C. As the drive wheel 56 causes the body 12 to rotate about the axis 13, the base 52 is also caused to rotate by the body 12 about the axis 13. The bearing elements 51C supporting the base 52 are rotated and are maintained in position by the bearing plates 51A.

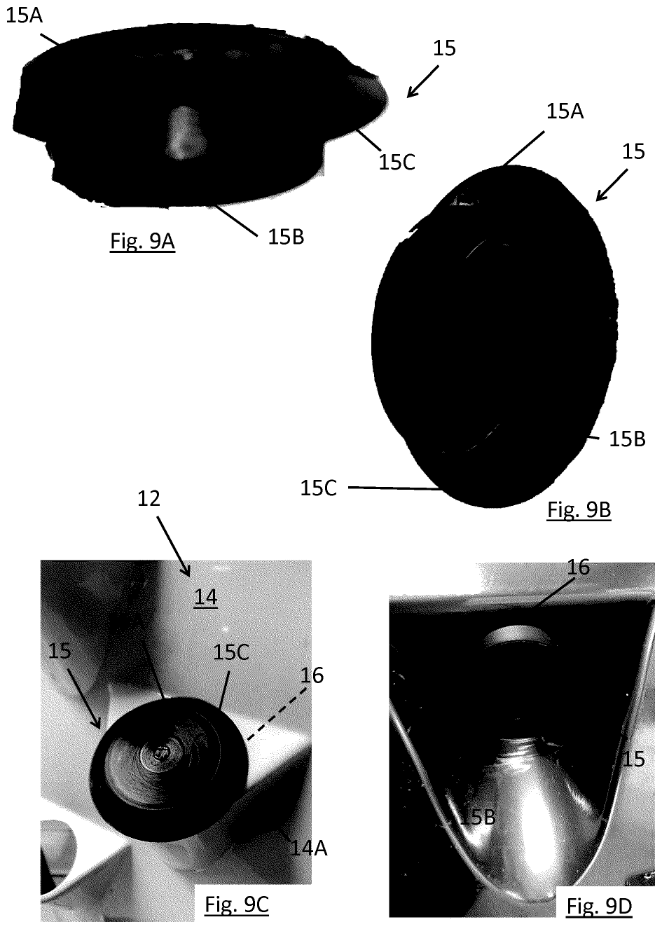

Referring to FIGS. 9A to 9D, the tower 10 has one or more caps 15. Each cap 15 is configured to be applied to one of the plant cavities 16 in the external walls 14 of the body 12 of the tower 10. Each cap 15 is configured to be inserted into one of the plant cavities 16 to block the plant cavity 16. Part of the cap 15 blocks the opening in the external wall 14 which defines part of the plant cavity 16 (see FIG. 9C), and another part of the cap 15 extends through the plant cavity 16 into the internal volume of the tower 10 (see FIG. 9D). The cap 15 may seal the plant cavity 16. The caps 15 therefore help to block off plant cavities 16 that are not being used to cultivate plants 11, thereby preventing water from within the tower 10 from exiting via uncovered plant cavities 16.

Referring to FIGS. 9A to 9D, one possible configuration of the cap 15 is shown. The cap 15 includes a cover portion 15A which abuts against or covers the protrusion 14A projecting outwardly from the external wall 14 and defining the plant cavity 16. The cover portion 15A is round in FIGS. 9A to 9D, and it may have other shapes as well. The diameter of the cover portion 15A is greater than the diameter of the opening in the external wall 14 which defines the plant cavity 16, thereby ensuring that the cover portion 15A blocks the entirety of the opening of the plant cavity 16. The cap 15 has an inserted portion 15B which is configured to be positioned in the plant cavity 16 to occupy the volume of the plant cavity 16. The inserted portion 15B is an annular cylinder in FIGS. 9A to 9D, and it may have other shapes as well. The diameter of the cover portion 15A is greater than the diameter of the inserted portion 15B. The inner portion 15B is closed or blocked to prevent water or material being conveyed through the cap 15. The cover portion 15A includes an annular flange 15C which extends radially outwardly from one end of the inserted portion 15B.

Referring to FIG. 9D, some of the inserted portion 15B is present within the internal volume of the body 12 of the tower 10 to block the opening of the plant cavity 16 from within the tower 10. One or both of the cover and inserted portions 15A,15B may be made of an elastomeric material, such as rubber or silicone. One or both of the cover and inserted portions 15A,15B may form a friction fit with their corresponding portions of the plant cavity 16 so as to seal the plant cavity 16. Other configurations and shapes for the cap 15 are possible.

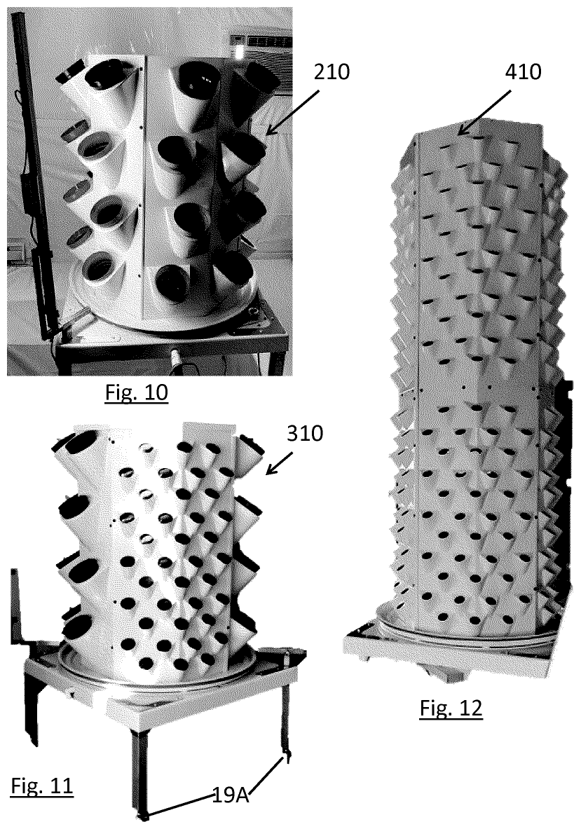

FIGS. 10 to 12 show different embodiments of the tower 210,310,410, and illustrates only some possible examples of different configurations of external walls 14, shapes and sizes of bodies 12, number of plant cavities 16 per external wall 14, and sizes and shapes for the plant cavities 16.

Referring to FIGS. 1A to 1C, there is disclosed a method of mounting the cultivatable plant 11 onto the plant cultivation object 10. The method includes inserting the cultivatable plant 11 into the hole 24 of the plant holder 24 to support the cultivatable plant 11 with the plant holder 20. The method includes mounting the plant holder 20 with the cultivatable plant 11 to the external wall 14 of the plant cultivation object 10.

Referring to FIGS. 7A to 8C, there is disclosed a method of rotating the plant cultivation 10 object the axis 13. The method includes driving the strap 54 engaged to a surface 52A of the plant cultivation object 10 to rotate the plant cultivation object 10 about the upright axis 13.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1.-27. (canceled)

28. A plant cultivation object, comprising:
a body having an upright orientation and extending along a longitudinal axis, the body having external walls with plant cavities; and
plant holders receivable in the plant cavities, the plant holders having one or more outer walls and one or more inner walls spaced inwardly from the outer walls, the one or more inner walls delimiting a hole, the plant holders being resiliently deformable.

29. The plant cultivation object of claim 28, wherein the plant holders are resiliently deformable to vary a size of the hole.

30. The plant cultivation object of claim 28 or 29, wherein the plant holders have a slot extending from the hole outwardly through the one or more inner walls and the one or more outer walls.

31. The plant cultivation object of claim 28, wherein the plant holders have an upper surface and a lower surface, a groove extending into the plant holders from one of the upper and lower surfaces toward the other of the upper and lower surfaces.

32. The plant cultivation object of claim 28, wherein the plant holders are made from a rubber-like material.

33. The plant cultivation object of claim 28, comprising one or more apertured cups each being receivable in one of the plant cavities, the plant holder being removably received in each apertured cup.

34. The plant cultivation object of claim 28, comprising one or more plants each being removably received in the hole of one of the plant holders.

35. The plant cultivation object of claim 28, comprising a plant growth media removably received in the hole of one or more of the plant holders.

36. The plant cultivation object of claim 28, wherein the body is rotatable about the longitudinal axis.

37. The plant cultivation object of claim 28, comprising a lighting system having an upright lighting arm spaced horizontally from the external walls of the body, and light emitting diodes (LEDs) disposed vertically along the lighting arm.

38. The plant cultivation object of claim 28, comprising a rotation system including a base supporting the body, the base being rotatable about an upright axis of the base.

39. The plant cultivation object of claim 38, wherein the rotation system includes a strap engaged with the base to rotate the base about the upright axis, and a motor drivingly engaged to the strap.

40. A method of mounting a cultivatable plant onto a plant cultivation object, the method comprising:
inserting the cultivatable plant into a hole of a plant holder to support the cultivatable plant with the plant holder, the plant holder being resiliently deformable, inserting the cultivatable plant into the hole including resiliently deforming the plant holder to vary a size of the hole; and
mounting the plant holder with the cultivatable plant to an external wall of the plant cultivation object.

41. The method of claim 40, wherein inserting the cultivatable plant into the hole includes resiliently deforming the plant holder to obtain a desired size of the hole.

42. (canceled)

43. The method of claim 40, wherein mounting the plant holder with the cultivatable plant includes squeezing the plant holder to reduce its size.

44. The method of claim 40, wherein mounting the plant holder with the cultivatable plant includes inserting the plant holder with the cultivatable plant into a cavity of the external wall of the plant cultivation object.

45. A plant holder mountable within a cavity of a plant cultivation object, the plant holder comprising: one or more outer walls and one or more inner walls spaced inwardly from the outer walls, the one or more outer walls abutting against the cavity upon the plant holder being mountable therein, the one or more inner walls delimiting a hole, a slot extending from the hole outwardly through the one or more inner and outer walls, the plant holder being resiliently deformable.

46. The plant holder of claim 45, wherein the plant holder is resiliently deformable to vary a size of the hole.

47. The plant holder of claim 45, comprising an upper surface and a lower surface, a groove extending into the plant holder from one of the upper and lower surfaces toward the other of the upper and lower surfaces.

48. The plant holder of claim 45, wherein the plant holder is made from a rubber-like material.

49. The plant holder of claim 45, comprising an apertured cup being receivable in the cavity, the plant holder being removably received in the apertured cup.

50. The plant holder of claim 45, comprising a plant being removably received in the hole of the plant holder.

51. The plant holder of claim 45, comprising a plant growth media removably received in the hole.
